(19) United States
(12) Patent Application Publication
(10) Pub. No.: US 2008/0199595 A1
(43) Pub. Date: Aug. 21, 2008

(54) SALT REPLACING COMPOSITION, PROCESS FOR ITS PREPARATION AND FOOD SYSTEMS CONTAINING SUCH COMPOSITION

(75) Inventors: Dmitriy V. Zasypkin, Cockeysville, MD (US); Michael A. Porzio, Monkton, MD (US)

Correspondence Address: OBLON, SPIVAK, MCCLELLAND MAIER & NEUSTADT, P.C., 1940 DUKE STREET, ALEXANDRIA, VA, 22314, US

(73) Assignee: McCormick & Company, Sparks, MD (US)

(21) Appl. No.: 11/675,356

(22) Filed: Feb. 15, 2007

(51) Int. Cl. A23L 1/237

(52) U.S. Cl. 426/649; 426/453

(57) ABSTRACT

A salt replacing composition for replacing sodium chloride in food contains a major amount of potassium chloride, ammonium chloride and at least one of an amino acid and a salt of an amino acid. A reduced sodium chloride composition contains the salt replacing composition and sodium chloride. A food containing the salt replacing composition and a process for making the salt replacing composition.

### BACKGROUND OF THE INVENTION

1. Field of the Invention

The present invention relates to a salt replacing composition. The invention further relates to food, seasonings, and flavorings that contain the salt replacing composition. The invention also relates to a process of flavoring a food by including the salt replacing composition of the invention.

2. Discussion of the Background

Salt in the form of sodium chloride is known to perform multiple functions in foods, including taste enhancement, preservation of foods by suppressing microbial activity and texture modification, as well as many other uses. High sodium intake favors the body's retention of water, which can cause hypertension, a proven risk factor in the development of heart disease, heart failure, strokes, and kidney disease. It has been recently recognized that a reduced level of sodium in foods could lead to a significant reduction in stroke and heart disease.

Many national and international organizations have published advisory guidelines for salt intake. Dietary Guidelines for Americans, jointly published in 2005 by the US Department of Health and Human Services (HHS) and the Department of Agriculture (USDA) state that “on average, the higher an individual's salt (sodium chloride) intake, the higher an individual's blood pressure. Nearly all Americans consume substantially more salt than they need”. The key recommendations include a recommendation to consume less than 2,300 mg of sodium per day (equivalent to about one teaspoon or 5.75 g of salt) and an advice to consume potassium-rich foods including fruits and vegetables. For some specific population groups including individuals with hypertension, individuals of African origin, and middle-aged or older adults the Guidelines recommend consumption of less than 1,500 mg of sodium per day (3.75 g of salt) and a minimum daily potassium intake of 4,700 mg. The best source of potassium is fruits and vegetables, which are rich in potassium in its acidic bicarbonate form.

The European Food Safety Authority (EFSA) estimates that the average individual daily intake of sodium in Europe is 3-5 g (8-11 g salt) while only 1 g of salt per day is required to maintain nutritional balance. The UK Food Standards Agency set a target of bringing down the average UK salt intake to 6 g a day, acknowledging that too much salt is a significant risk factor in developing high blood pressure. According to the UK Food Standards Agency, high blood pressure can triple the risk of heart disease and stroke. The World Health Organization (WHO/FAO, 2005) recommends 5 g of salt as the daily intake limit.

There is a significant need to reduce dietary sodium intake much of which (up to 75%) originates in processed foods manufactured by the food industry and the related food service sector. There is also a need to balance sodium intake with an increased level of potassium.

There have been numerous attempts to address the issue by substituting sodium with potassium or other food salts or acids. Compositions that are used to replace or substitute for sodium chloride are known as salt replacing compositions or sodium chloride replacing compositions. Earlier patents including U.S. Pat. Nos. 1,874,055 and 1,772,183 replaced sodium with acids and acidic salts in various combinations with some success. However, unbalanced sour or chalky notes precluded significant use of such salt substituting compositions.

Other patents have focused on potassium chloride (KCl) as a major component in salt substituting compositions. Depending on concentration and application level, KCl imparts a sour salty sensory perception with very significant metallic and bitter off-notes. Masking of these unacceptable off-notes has become a major challenge and has been attempted with a number of food ingredients, including various salts, organic acids, salts of the organic acids, sweeteners, hydrolyzed vegetable proteins, autolyzed yeasts, amino acids and their salts, most recently salts of nucleic acids.

U.S. Pat. No. 2,471,144 to Davy describes a salt substitute composition containing 66% KCl, 12% NH₄Cl, 17% starch, 3% potassium formate, 1% calcium formate, and 1% magnesium citrate. The composition imparts strong acidity, is moderately salty and, has cardboard and metallic aftertastes.

U.S. Pat. No. 4,243,691 to Mohlenkamp et al. describes a composition containing 33.3% potassium chloride, 26.5% dipotassium orthophosphate, 25.8% hydrolyzed vegetable protein (HVP), 10.5% glucose, 2% 5′-guanosinic acid and 1.9% 5′-inosinic acid. In addition to salty notes the composition has significant umami, some metallic, strong meaty and slight chalky notes.

U.S. Pat. No. 4,216,244 to Allen describes a low sodium salt seasoning. Two compositions are described in particular: A) 92.4% KCl, 3% L-glutamic acid, 1% monopotassium glutamate (MPG), 1.3% potassium citrate, 1.3% potassium phosphate, 1% anticaking agent; and B) 90.5% formula 1) plus 9.5% lactose. The composition A) significantly masks metallic tastes. However, it also has a sour bite, unbalanced acidity, meaty mid- and after-taste. Composition B), while mitigating some metallic, sour and meaty notes, is far from salty in overall character and imparts lower salt intensity compared to composition A.

U.S. Pat. No. 4,340,614 to Pich, et al., describes a stringently sodium-restricted dietetic salt and its preparation. The composition comprises of 60-85% KCl, 10-30% potassium adipate, 2-5% potassium tartrate, 0.5-2% potassium glutamate, 0.5-2% adipic acid, 0.004-0.06% potassium inosinate and/or potassium guanylate. The composition has low salty taste intensity, imparts significant sour and meaty notes that are especially obvious at the low salt intensity.

EP 0125021 B1 to Kiyoshi et al. describes a seasoning composition containing 100 parts KCl, 1.5-30 parts of calcium salt of organic acid (e.g., calcium lactate), 1-30 parts salt of glutamic acid (e.g., monosodium glutamate (MSG)), or/and 0.01-5 parts of nucleotides (e.g., salts of 5′-inosinate and/or 5′-guanylate). The composition imparts relatively low salt intensity, very significant meaty and slight bitter/metallic notes.

EP 0124254 B1 to Arciszewski at al. describes a salt substitute composition. The composition contains 70-98% KCl, 1-20% nonreducing sugar (sucrose preferred), 0.15-5% anticaking agent (tricalcium phosphate), 0.3-15% organic acid (adipic), and 0.5-10% glutamate salt (MPG preferred). The composition has some unbalanced sour, chalky and metallic/meaty notes.

U.S. Pat. No. 5,064,663 to Murray, et al. describes a sodium chloride substitute containing autolyzed yeast and ammonium chloride. The composition contains: A) one part ammonium chloride to about four parts autolyzed yeast or B) KCl 0.5 to 20 parts by weight to one part of autolyzed yeast and ammonium chloride mixture as in claim A). The compositions have overpowering meaty notes and some metallic notes.

U.S. Pat. No. 5,494,689 to Lee at al. describes a food-acceptable ammonium salt encapsulated in a food-acceptable carrier as a salt enhancer in dehydrated meat, vegetable or dairy substances. The salt enhancing composition enables reduction of sodium chloride content.

U.S. Pat. No. 5,711,985 to Guerrero et al. describes a salty taste enhancing dehydrated composition containing from about 15% to about 65% by weight of an ammonium salt and from about 35% to about 85% by weight of proteolyzed protein. The proteolyzed protein contains from about 0.2% to about 3% free lysine and from about 0.2% to about 3% free arginine. In addition, the proteolyzed protein includes from about 0.2% to about 5% free glutamic acid. The patent also describes a salt extender product comprising granular sodium chloride and the salty taste enhancing composition.

U.S. Pat. No. 5,853,792 to Zolotov et al. describes a low sodium edible salt composition and process for its preparation. The composition contains 0-50% NaCl, 45-99.5% KCl and at least 0.5% additives, which comprise at least one edible nucleotide monophosphate salt, a burnt sugar, and at least one member other than said nucleotide monophosphate salt, for example, a low molecular weight organic acid (preferred citric, tartaric, lactic, gluconic and acetic), phosphoric acid (sodium pyrophosphate preferred), phosphate salt, a magnesium salt and sugar. The composition imparts bitter/metallic and meaty notes if taken without sodium chloride. In presence of at least 25% by weight of sodium chloride, the off-notes are reduced.

U.S. Pat. No. 6,783,788 to Kuroda et al. describes seasoning compositions, foods containing such a seasoning composition, and a process for preparing such foods. The compositions include 100 parts KCl (potassium chloride), 0.2-5 parts of a sugar alcohol, 1-7.5 parts of MSG (monosodium glutamate), 1-10 parts sucrose, 0.05 to 1 part of sodium inosinate (IMP) and/or sodium guanylate (GMP). Negative sensory attributes imparted by the compositions include strong meaty and slight savory/metallic aftertaste.

WO 2006/013997 A1 to Kuroda et al. describes a seasoning composition, seasoning material and process for producing food therewith. The patent describes the following composition: 100 parts KCl, 1.5-70 parts histidine or salts thereof, 4-100 parts lysine or salts, 2-100 parts of IMP and/or GMP (sodium inosinate and/or sodium guanylate), 20-130 parts of lactic acid or salts, and 5-50 parts of phosphoric acid or salts thereof. The composition has unbalanced meaty and acidic character with some chalky aftertaste.

Evaluations of commercially available salt replacing compositions in solutions and topically on cucumber and/or tomato slices showed unacceptable metallic, bitter or chalky off-notes. Some compositions may have been able to substantially cover metallic and chalky off-notes, however otherwise remained unbalanced in terms of sour, meaty or other savory notes. Other compositions are relatively balanced but exhibit low intensity or uncharacteristic salty character. In addition, some of the components of the previously described compositions may not be acceptable in some applications for the reasons of their potential allergenic reactions, limited stability during processing of food or potential interactions with other food ingredients. Therefore, there is a need for improved salt replacing compositions having desirable taste characteristics and suitable ingredient properties in the specific foods.

### SUMMARY OF THE INVENTION

Accordingly, it is one object of the present invention to provide a salt replacing composition.

It is another object of the invention to provide a salt replacing composition that significantly reduces or completely eliminates metallic/bitter notes of potassium chloride, enhances salty character and increases the intensity of the true salty taste while keeping the overall taste of foods balanced.

It is another object of the invention to provide a salt replacing composition that may be efficiently used as a sodium chloride/table salt replacer for topical and/or ingredient mix applications.

It is another object of the invention to provide condiments and intermediate food preparations such as dough, minced meat, cheese curd, coatings and other food products containing a salt replacing composition.

It is another object of the invention to provide a salt replacing composition that reduces sodium and increases potassium level in foods.

It is another object of the invention to provide a reduced salt seasoning composition having a decreased amount of sodium and an increased amount of potassium in comparison to sodium chloride.

It is another object of the present invention to provide a process for preparing a salt replacing composition, which controls the degree of mixing of the components, structure and size of particles of the salt replacing composition.

It is another object of the invention to provide a process for controlling the impact of salty taste, enhancing the masking of undesirable off-notes and/or improving salty character in seasonings.

It is another object of the present invention to provide foods, which include a salt replacing composition or a reduced salt composition and have a good, intense and balanced salty taste and reduced sodium and increased potassium content.

These objects, as it will become apparent in the following detailed description, have been achieved by the inventors' discovery that in certain salt replacing compositions the metallic/bitter off-notes of potassium chloride can be efficiently masked, the salty character enhanced, the salty taste intensity can be increased and balanced, to the extent the composition can efficiently replace sodium chloride/table salt in various final and intermediate food applications. The inventors discovered that a synergistic sensory interaction of potassium chloride, ammonium chloride, and some amino acids in pure form not only masked bitter/metallic notes of potassium chloride but also enhanced true salty character and increased salt intensity. The effect has been achieved at significantly lower levels of components other than potassium chloride compared to many existing salt replacing compositions that contain some of the components. It was further discovered that a sugar, an organic acid and/or salt thereof, and some other components including emulsifiers and flavors may additionally help to balance the composition. True balanced salty character was found to dominate in a wide range of application levels of the salt replacing composition of the invention.

### DETAILED DESCRIPTION OF THE PREFERRED EMBODIMENTS

In one embodiment, the present invention provides a salt replacing composition which can eliminate or reduce the amount of sodium chloride in food, seasonings or flavorings and provide a good salty taste to food.

In embodiments, the salt replacing composition of the invention may comprise:

(i) 75-95%, preferably, 80-90% by weight of potassium chloride,

(ii) 2-15%, preferably, 6-10% by weight of ammonium chloride,

(iii) 0.05-10%, preferably, 0.5-3% by weight of at least one of an amino acid and a salt of an amino acid,

(iv) up to 5%, preferably, 0.1-2% by weight of at least one organic acid selected from the group consisting of acetic acid, citric acid, tartaric acid, succinic acid, malic acid, lactic acid, fumaric acid, adipic acid, and ascorbic acid,

(v) up to 10%, preferably, 0.1-5% by weight of at least one sweetener selected from the group consisting of sucrose, trehalose, lactitol, erythritol, maltitol, sorbitol, mannitol, xylitol, and a hydrogenated starch hydrolyzate,

(vi) up to 5%, preferably, 0.1-3% by weight of at least one of a taste enhancing agent and a masking agent wherein the taste enhancing agent and the masking agent are selected from the group consisting of a flavor, a flavor adjuvant, a flavor enhancer, an emulsifier and mixtures thereof, and

(vii) up to 5%, preferably, 0.1-2% by weight of disodium inosinate, disodium guanylate, or mixtures thereof,

wherein % by weight is based upon the total weight of (i), (ii), (iii), (iv), (v), (vi), and (vii).

The salt replacing compositions imparted intense and balanced salty character in solutions and in many foods including topically on vegetables, in seasonings applied to chips, coatings applied to fried meats, in soups and gravies, in mashed green beans, crackers, and other food applications.

A most preferred salt replacing composition, when compared to other naturally occurring, patented, or conventional compositions at the same level of salt or sodium reduction in foods, provides a more intense salty taste and better balanced sensory attributes similar to those of table salt versions of the foods.

The salt replacing composition of the present invention may exist as a powder, granular blend, or a liquid, and may occur as one component of a mixture of components such as a final food or intermediate food prepared with this salt replacing composition. One preferred form of the salt replacing composition is a homogeneous powder constituted of particles with the size in the range from one micrometer to about three millimeters. The particles can have various shapes and physical structure from pure crystalline to completely amorphous glassy. The shape and physical structure in some cases are determined by the processes involved in the preparation of original constituents while in other cases result from additional processing of the primary components, as described in this section. The particles in the identified size range may have an internal structure of clusters or aggregates of smaller particles. The presence of free particles with a size under one micrometer will typically cause segregation, dusting, electrostatic attraction in processing, and therefore is not preferred in this invention.

Potassium chloride is a major component of the salt replacing composition of the invention. It provides salty and sour attributes to the composition, balance of which depends on potassium chloride concentration. It also comes with known metallic/bitter off-notes which are highly undesirable and have to be mitigated. Potassium chloride is also a source of potassium ions that are recommended in a diet to counterbalance sodium.

As a major component of the salt replacing composition, potassium chloride may be the single component that is present in the highest amount when calculated based on the weight of the potassium chloride relative to the weight of the total composition. Alternatively, potassium chloride may be present as a major component where potassium chloride represents at least 50 wt % based on the weight of the potassium chloride in comparison to the weight of the entire composition. Preferably, the potassium chloride is present in an amount of at least 50 wt %, more preferably potassium chloride is present in an amount of at least 55 wt %, even more preferably, 60 wt %, even more preferably 65 wt %, especially preferably 70 wt %, even more especially 75 wt %. In other embodiments, potassium chloride is present in an amount of 80 wt %, 85 wt %, 90 percent, 95 wt %, or 99 wt %. When percent by weight (wt %) is calculated, the amount of inert, non-flavoring components is not included in the total weight of the composition.

The potassium chloride can be in any purified form including powder, granule, solution, dispersion or slurry. Food grade materials rich in potassium chloride can also be used as a source of potassium chloride. The source can be from purified mineral deposits as well as from sea water bittern as an example. One preferred form of potassium chloride is its pure crystalline form that may include up to 2%, preferably, less than 1% by weight of sodium chloride and other impurities. Potassium chloride is also available in a pure form containing less than 50 ppm of sodium in the form of sodium chloride.

Ammonium chloride is present in the salt replacing composition of the invention. The ammonium chloride may impart a salty and sour taste. In the amounts used in the salt replacing composition, ammonium chloride does not introduce any off-notes and helps to reduce metallic/bitter off-notes imparted by potassium chloride. In combination with amino acids and other disclosed components of the blend it synergistically enhances salty character and increases the salt intensity of the salt replacing composition. The synergistic effect permits lower amounts of the components to be used while still enhancing salty character and masking bitterness induced by potassium chloride. Ammonium chloride in the composition can be in any purified food grade form. Most common form is the anhydrous crystalline form. Ammonium chloride can also be used as a solution, dispersion or concentrated slurry. Optionally, ammonium chloride crystals could be coated or otherwise encapsulated for additional protection against moisture, caking and interaction with other components.

Food grade ammonium chloride is produced by the reaction of sodium chloride and an ammonium salt in solution. The less soluble sodium salt separates out at elevated temperatures, and ammonium chloride is recovered from filtrate on cooling. Alternatively, hydrogen chloride formed by the burning of hydrogen in chlorine is dissolved in water and then reacted with gaseous ammonia. Then ammonium chloride is crystallized from the solution. Ammonium chloride meets the specifications of the Food Chemicals Codex, 3d Ed. (1981) p. 20, which is incorporated by reference. According to the Code of Food Regulations (CFR) v. 21, paragraphs 184.1(b) (1) and 184.1138, incorporated herein by reference, ammonium chloride can be used in food with no limitation other than current good manufacturing practice. More specifically, in the salt replacing composition of this patent ammonium chloride is used as a flavor enhancer.

Amino acids and their salts are an essential part of the salt replacing composition. They enhance salty character and increase the salty taste intensity of the composition through synergistic interaction with other components in the composition. In addition, if a partial salt reduction is to be achieved then amino acids and their salts can additionally enhance salty taste of the conventional salt in the composition.

There are many types of amino acids and, in fact, about 500 kinds of amino acids have been discovered in nature. However, only 20 amino acids serve as the constituents of food proteins and our body. Various combinations of these 20 amino acids produce as many as 100 thousand various proteins. Proteins contained in food are first degraded to the 20 amino acids, and then reassembled into proteins in the body. The 20 amino acids include valine, leucine, isoleucine, alanine, arginine, glutamine, lysine, aspartic acid, glutamate, proline, cysteine, threonine, methionine, histidine, phenylalanine, tyrosine, tryptophan, asparagine, glycine, and serine. The following nine amino acids are essential and are not synthesized in the body: valine, leucine, isoleucine, lysine, threonine, methionine, histidine, phenylalanine, and tryptophan.

Most preferred amino acids of the present invention are lysine, arginine, glutamic acid and the salts of the amino acids. The salts include the sodium and potassium salts of glutamic acid known as, respectively, sodium and potassium glutamates. The most preferred salts of lysine and arginine are lysine hydrochloride and arginine hydrochloride, respectively. Amino acids and their salts may include water in their crystalline structure forming crystal hydrates. Naturally, amino acids are mainly present in their left-hand stereo isomeric form simple denoted as L-form, for example, L-arginine. However, a small fraction of a right-hand form denoted as D-form is typically present. A mixed composition of the forms can be prepared. In this invention, most common L-form of the amino acids is preferably used.

Amino acids are commercially produced via two major pathways: fermentation and protein hydrolysis. Currently, the amino acids are mainly manufactured by a fermentation method. In this method some selected strains of microorganisms convert natural raw materials such as syrups and sugars in a culture media into amino acids. A fermentation tank is filled with syrups/sugars derived from sugar cane, corn, and cassaya, and then fermentation conditions are set so that the stirring conditions, air supply, temperature, and pH are optimum. Consecutive reactions by 10 to 30 types of enzymes are involved in the process of fermentation, and various amino acids are produced as a result of these reactions. Finally, the target amino acids are produced from this fermented broth in high purity.

According to a manufacturer's specification (Ajinomoto USA, Inc.) the purified ammo acids contain not less than 98.5% and not more than 101% of a pure amino acid, 0.5% moisture, 0.1% ash. Total impurities including other amino acids are determined chromatographically. The number of impurity peaks does not exceed four and total impurities do not exceed 2% by weight of the amino acid.

Amino acids in the presence of moisture could react with reducing sugars, forming the products of Maillard reaction. The reaction is significantly accelerated at elevated temperatures, at pH close to neutral, and intermediate moisture (15-30% water by weight) in a composition. Amino acids can be optionally protected by a coating or other encapsulating agent to prevent caking and reaction with other components. An efficient way to prevent the reaction is to use non-reducing sweeteners. These sweeteners are preferred in this invention.

Organic acids may include any of citric, tartaric, succinic, malic, lactic, fumaric, adipic, and ascorbic acids. Their acidic salts include sodium, potassium, and calcium salts and their hydrate crystal forms. The preferred organic acid is citric acid, while most preferred salts of organic acids include various sodium or potassium salts of citric acid and potassium bitartrate also known as cream of tartar. Organic acids or their salts can be in a powder, granular, or liquid form. Hydrate crystal forms of organic acids or their salts can be used. Organic acids or their salts can also be used individually or in a combination. Organic acids can be protected by a coating or encapsulated to prevent caking and reaction with other components.

Sweeteners include any sugar, e.g., sucrose, dextrose, lactose, maltose, fructose, trehalose, and mannose, sugar alcohol including mannitol, maltitol, erythritol, xylitol, sorbitol, lactitol, palatinol, corn syrup solids having a dextrose equivalent above or equal 24 and hydrogenated corn syrup solids. High intensity sweeteners including aspartame, potassium acesulfame, cyclamate, saccharin, sucralose, neotame, Stevia extract and others can be used in a concentrated or a diluted form as a sweetener. The sweetener in the salt replacing composition can be a combination of the sweeteners listed above. The most preferred sweetener in the composition is sucrose.

The sucrose present in the salt reducing composition may function to balance the taste, somewhat masking bitterness and excessive sour taste, and enhancing salty character. Sucrose is a non-reducing sugar and is less reactive compared to many other sugars when considered as a part of a composition that includes amino acids, the salts of amino acids and ammonium chloride, all known to react with reducing sugars. Sucrose may provide longer shelf-life to the salt replacing composition when in the form of a dry blend and assures stability and better functionality of the composition in heated food applications containing moisture. Sucrose can be in any form including granulated sugar, brown sugar, and soft sugar, for example. Highly purified crystalline sugar is preferred for most food applications.

A flavor can be added to the salt replacing composition to enhance the salty character of the composition in a specific food application, help to balance the overall flavor and/or to additionally mask some undesirable notes resulted from sensorial interaction of ingredients in the food. The term flavor includes spice oleoresins and oils derived from any of allspice, basil, capsicum, cinnamon, cloves, cumin, dill, garlic, marjoram, nutmeg, paprika, black pepper, rosemary and turmeric; essential oils including anise oil, caraway oil, clove oil, eucalyptus oil, fennel oil, garlic oil, ginger oil, peppermint oil, onion oil, pepper oil, rosemary oil, and spearmint oil; citrus oils such as orange oil, lemon oil, bitter orange oil and tangerine oil; alliaceous flavors including garlic, leek, chive, and onion; botanical extracts including arnica flower extract, chamomile flower extract, hops extract, and marigold extract; botanical flavor extracts including blackberry, chicory root, cocoa, coffee, kola, licorice root, rose hips, sassaparilla root, sassafras bark, tamarind, licorice, and vanilla extracts; protein hydrolysates including hydrolyzed vegetable protein (HVPs), meat protein hydrolysates, milk protein hydrolysates; compounded flavors both natural and artificial including those disclosed in S. Heath, Source Book of Flavors, Avi Publishing Co. Westport, Conn., pp. 149-277, 1981, which is incorporated herein by reference in its entirety; and processed (reaction) flavors prepared through a Maillard type reaction between reducing sugars and protein derived components including amino acids. Representative individual flavor compounds include benzaldehyde, diacetyl (2,2-butanedione), vanillin, ethyl vanillin and citral (3,7-dimethyl-2,6-octadienal).

A flavor adjuvant or flavor enhancer can be optionally added to the composition to further enhance the salty character of the composition in a specific food application, help to balance the overall flavor or additionally mask some undesirable notes resulted from sensorial interaction of ingredients in the food. Flavor adjuvants or flavor enhancers can include various classes of food additives including organic acids, fatty acids, salts of organic acids, and emulsifiers. Potassium iodide may be added to provide a micronutrient that is necessary in the diet.

An emulsifier can be optionally added to further improve salty character of the composition in some applications. Emulsifiers include distilled monoglycerides, ethoxylated monoglycerides, lactylated monoglycerides, acetylated monoglycerides, diacetyl tartaric acid esters of monoglycerides (D.A.T.E.M.'s), propylene glycol monoesters, sorbitan monostearate, sorbitan tristearate, polyglycerol esters of fatty acids, sorbitan polyoxyethylene monoester and triesters, sucrose esters, sodium stearoyl lactylate (S.S.L.), lecithin, hydroxylated lecithin, oleyl lactylic acid, lactylated esters of monoglycerides, lactylated esters of propylene glycol and monoglycerides, sodium lauryl sulfate, cetyl pyridinium salt, and the sodium and potassium salts of fatty acids singly or in combination. The emulsifier(s) may be present in an amount of up to 0.5% in the salt replacing composition. Sodium lauryl sulfate is a preferred emulsifier.

Disodium inosinate can be used individually or in a combination with disodium guanylate. These components of the salt replacing composition are also known as inosine 5′-monophosphate disodium salt or guanosine 5′-monophosphate disodium salt hydrate, respectively. Alternatively, the ingredients can be named 5′-inosinic acid disodium salt hydrate or 5′-guanylic acid disodium salt hydrate, respectively. Potassium or ammonium salts of the inosinic or guanosinic acids may be used in a salt replacing composition.

Both disodium inosinate and guanylate could work synergistically with ammonium chloride, amino acids and their salts to enhance the salty character of potassium chloride while masking its bitter/metallic off-notes in the salt replacing composition of the invention. Hydrate crystal forms of disodium inosinate and disodium guanylate can be used.

A flow agent can be optionally added to the salt replacing composition or any component of the salt replacing composition and selected, for example, from silicon dioxide, fumed silica, sodium alumino silicate, basic magnesium carbonate, tricalcium phosphate, magnesium oxide, calcium silicate, powdered and crystalline cellulose, sodium ferrocyanide decahydrate, and starch.

The salt replacing composition can be blended at any ratio with sodium chloride to achieve any desirable salt or sodium reduction. Sodium chloride improves the salty character and intensity of the salt replacing composition. Sodium chloride can be in any liquid or solid crystalline form originating from mineral or rock salt, sea salts including reduced sodium sea salt additionally containing potassium chloride and other salts, and other significant sources of sodium chloride.

When used as a dry blend, the salt replacing composition may have components with comparable particle sizes to avoid segregation of the components. The components in some cases may be ground, milled, sieved or otherwise processed to bring the particles or fractions to the desired size tailored to an application for the desired kinetics of taste and aroma impact. Typically, particles in the preferred composition will have sizes in the range from one micrometer to three millimeters. In some cases, these particles may constitute aggregates of submicron size particles clamped together to form a larger aggregate. Having submicron particles in a free form can cause significant dusting, segregation, and electrostatic adherence problems. The salt replacing composition to be used as a table salt preferably will have particles in the range from 20 to 60 mesh of US Standard sieve size.

The invention also provides a process for preparing the salt replacing composition or the reduced salt composition. The salt replacing compositions can be prepared by straight blending of the components. In addition, whenever smaller particles are desired, the components can be co-milled, dissolved or dispersed and dried, for example, spray-dried, ball milled or otherwise reduced by any of the available techniques. If larger particles are desired, an agglomeration and/or a coating process including fluidized bed coating, or an extrusion process combined with drying and milling may be used.

In a further embodiment, the invention provides a food having reduced sodium chloride/sodium content and an intense balanced salty taste, and containing the salt replacing composition or the seasoning composition of the invention.

Examples of foods which may include the present salt replacing or seasoning composition include any food to which sodium chloride is added to enhance the salty taste and/or the flavor in general. Such foods include but are not limited to soups, snacks, and foods with a coating, condiments (including sauces, rubs, marinades, dressings, salsas, and the like), meats, vegetables, fruits, cereals, processed foods, flavored seasonings, ingredient blends and flavorings.

Other details and features of the compositions described in the present invention will be more apparent from the exemplary embodiments, which are provided for illustration of the invention and are not intended to be limiting thereof.

### EXAMPLES

The following examples further illustrate the preferred embodiments and functionality of the salt replacing and seasoning compositions.

### Example 1

400 g of dry powder components made up of 85.58% of potassium chloride, 7.68% of ammonium chloride, 3.79% of sucrose, 0.49% of anhydrous citric acid, 0.98% agrinine, and 1.48% of McCormick natural flavor F26348 were mechanically blended and shaken in a closed container to form a salt replacing composition.

Crackers were prepared by baking a dough in the conventional oven at 350 F for 10 min. The dough composition included wheat flour, sugar, corn syrup solids, leavening agent, shortening, and salt. Control crackers contained 25% less salt of the full amount of salt in the original composition. Sample crackers contained 25% less salt that was replaced with an increased amount of the salt replacing composition of this example. The amount of the salt replacing composition was increased by 15% compared to the weight of eliminated salt.

A panel of 10 trained external descriptive panelists evaluated the crackers, using a degree of difference scale from 1 to 10. Crackers containing 25% less salt scored 6.7 with the comments on reduced total flavor, reduced salt and increased metallic. Crackers containing the salt replacing composition scored 8.4 with the comments on increased total flavor and increased salt. The score 8.4 is considered to be well within acceptability range, however, is not a perfect match to the full salt control scoring from 9 to 10 on the evaluation scale.

### Example 2

400 g of dry powder components made up of 86.22% of potassium chloride, 7.75% of ammonium chloride, 3.82% of sucrose, 0.25% of anhydrous citric acid, and 1.96% of McCormick natural flavor F26348 were mechanically blended and shaken in a closed container to form a salt replacing composition.

Plain potato chips containing no seasoning were warmed up in a bag in microwave oven and seasoned with sodium chloride in the form of granular salt used as control, a 1:1 blend by weight of sodium chloride/potassium chloride, or a 1:1 blend by weight of sodium chloride/the salt replacing composition. Sodium content was reduced from 180 mg of sodium per serving in the full salt control chips down to 80 mg of sodium per serving in the experimental chips. A panel of eight trained descriptive panelists evaluated the chips, using a degree of difference scale from 1 to 10. The salt replacing composition mixed with the equal weight of sodium chloride scored 7.6. This was significantly higher than the score of 6.7 for the chips containing equal amounts of sodium and potassium chloride. A score above 7.0 is considered to be acceptable though not a match to the full salt control.

### Example 3

400 g of dry powder components made up of 86.4% by weight of potassium chloride, 7.77% of ammonium chloride, 3.83% of sucrose, 0.5% of anhydrous citric acid, 0.25% monopotassium glutamate, and 1.25% of disodium inosinate (IMP)/disodium guanylate (GMP) blend (about 1:1 IMP/GMP blend by weight) were mechanically blended and shaken in a closed container to form a salt replacing composition.

The salt replacing composition was compared against a commercially available composition SALTLESS comprising potassium chloride, monopotassium glutamate, glutamic acid, tricalcium phosphate, and 0.01% by weight of potassium iodide. English cucumber slices were topically seasoned with 0.1 g of the compositions and compared side by side by eight internal panelists routinely participating in sensory panels. The paired forced choice sensory panel required to choose a sample with the higher salt intensity and give preference to a sample. All panelists indicated that the salt replacing composition of this example was more salty. Seven out of eight panelists preferred the same composition. One panelist did not like the composition on the basis of too strong salty impact. The same panel test was run on Roma tomato slices. Seven out of nine panelists identified the slices seasoned with the salt replacing composition of the Example 1 as more salty, the preference being a split: five panelists preferred the samples seasoned with SALTLESS, apparently, according to the comments, due to variability in bitter/green notes coming from the tomato slices in the aftertaste.

### Example 4

400 g of a powder made up of 85.56% by weight potassium chloride, 7.58% of ammonium chloride, 3.79% of sucrose, 0.49% citric acid, 0.98% of citric acid, 0.98% of arginine, and 1.48% of McCormick natural flavor F26348 were mechanically blended and shaken in a closed container to form a salt replacing composition.

The salt replacing composition was compared side by side against the salt replacing composition of the Example 3 by tasting 2% aqueous solutions. The paired forced choice panel required to identify a sample which is more salty, preferred by overall sensory perception, and is more bitter/metallic. All five panelists identified the salt replacing composition of this example as more salty and preferred. Two panelists described the composition as more bitter/metallic while three other panelists assigned more bitter/metallic to the composition of the Example 3.

### Example 5

400 g of dry powder components made up of 86.76% of potassium chloride, 7.8% of ammonium chloride, 3.84% of sucrose, 0.2% of anhydrous citric acid, 0.8% of McCormick natural flavor F26348, and 0.6% of potassium bitartrate were mechanically blended and shaken in a closed container to form a salt replacing composition.

Plain potato chips containing no seasoning were warmed up in a bag in microwave oven and seasoned with sodium chloride in the form of granular salt used as control or a 1:1 blend by weight of sodium chloride/the salt replacing composition. Sodium content was reduced from 180 mg of sodium per serving in the full salt control chips down to 80 mg of sodium per serving in the experimental chips. In one set of chips the salt level was reduced to 80 mg of sodium while in the second set of chips salt was reduced by the same amount and 100 mg of the salt replacing composition was added. A panel of seven trained descriptive panelists evaluated the chips, using a degree of difference scale from 1 to 3, 3 being a perfect match to control. The salt replacing composition mixed with the equal weight of sodium chloride scored 2.7. This was markedly higher than a score of 2.1 for the chips with the reduced amount of salt and no salt replacer added.

### Example 6

100 g of dry powder components made up of 99.4% by weight of the composition of the Example 1 and 0.6% potassium bitartrate were mechanically blended and shaken in a closed container to form a salt replacing composition.

The salt replacing composition was compared against a commercially available composition NoSalt® comprising potassium chloride, potassium bitartrate, adipic acid, silicon dioxide, mineral oil and fumaric acid. Roma tomato slices were topically seasoned with 0.1 g of the compositions and compared side by side by six internal panelists routinely participating in sensory panels. The paired forced choice sensory panel requested to choose a sample with the higher salt intensity, higher bitter/metallic notes, and to give overall preference to a sample. Five out of six panelists described the salt replacing composition of this example as less bitter and more preferred. It was the equal split between the panelists as to the salt intensity.

1. A sodium chloride replacing composition, comprising:
75-95% by weight of potassium chloride,
2-15% by weight of ammonium chloride, and
0.05-10% by weight of at least one of an amino acid and a salt of an amino acid,
wherein % by weight is based on the total weight of the composition.

2. The salt replacing composition of claim 1, comprising at least one amino acid selected from the group consisting of lysine, arginine, and glutamic acid.

3. The salt replacing composition of claim 1, comprising at least one salt of an amino acid selected from the group consisting of lysine hydrochloride, arginine hydrochloride, and a salt of glutamic acid.

4. The salt replacing composition of claim 3, wherein the salt of an amino acid is one or more of a sodium salt, a potassium salt, and a calcium salt of glutamic acid.

5. The salt replacing composition of claim 1, further comprising of 0.1-5% by weight of at least one organic acid selected from the group consisting of acetic acid, citric acid, tartaric acid, succinic acid, malic acid, lactic acid, fumaric acid, adipic acid, and ascorbic acid.

6. The salt replacing composition of claim 5, wherein the organic acid is present in the form of at least one of a sodium salt, a potassium salt, and a calcium salt.

7. The salt replacing composition of claim 1, further comprising 0.1-10% by weight of at least one sweetener selected from the group consisting of sucrose, trehalose, lactitol, erythritol, maltitol, sorbitol, mannitol, xylitol, and a hydrogenated starch hydrolysate.

8. The salt replacing composition of claim 5, further comprising:
0.1-10% by weight of at least one sweetener selected from the group consisting of sucrose, trehalose, lactitol, erythritol, maltitol, sorbitol, mannitol, xylitol, and a hydrogenated starch hydrolysate.

9. The salt replacing composition of claim 1, further comprising:
up to 5% by weight of at least one of a taste enhancing agent and a masking agent, wherein the taste enhancing agent and the masking agent are selected from the group consisting of a flavor, a flavor adjuvant, a flavor enhancer, an emulsifier and mixtures thereof.

10. The salt replacing composition of claim 5, further comprising:
up to 5% by weight of at least one of a taste enhancing agent and a masking agent, wherein the taste enhancing agent and the masking agent are selected from the group consisting of a flavor, a flavor adjuvant, a flavor enhancer, an emulsifier and mixtures thereof.

11. The salt replacing composition of claim 7, further comprising:
up to 5% by weight of at least one of a taste enhancing agent and a masking agent, wherein the taste enhancing agent and the masking agent are selected from the group consisting of a flavor, a flavor adjuvant, a flavor enhancer, an emulsifier and mixtures thereof.

12. The salt replacing composition of claim 8, further comprising:
up to 5% by weight of at least one of a taste enhancing agent and a masking agent, wherein the taste enhancing agent and the masking agent are selected from the group consisting of a flavor, a flavor adjuvant, a flavor enhancer, an emulsifier and mixtures thereof.

13. The salt replacing composition of claim 1, further comprising:
0.1-5% by weight of disodium inosinate, disodium guanylate or a mixture thereof, wherein the salt replacing composition does not comprise salts of glutamic acid, and wherein % by weight is based on the inosinate and the guanylate and the total weight of the salt replacing composition.

14. The salt replacing composition of claim 5, further comprising:
0.1-5% by weight of disodium inosinate, disodium guanylate or a mixture thereof, wherein the salt replacing composition does not comprise salts of glutamic acid and wherein % by weight is based on the inosinate and the guanylate and the total weight of the salt replacing composition.

15. The salt replacing composition of claim 7, further comprising:
0.1-5% by weight of disodium inosinate, disodium guanylate or a mixture thereof, wherein the salt replacing composition does not comprise salts of glutamic acid and wherein % by weight is based on the anhydrous form of the inosinate and the guanylate and the total weight of the salt replacing composition.

16. The salt replacing composition of claim 8, further comprising:
0.1-5% by weight of disodium inosinate, disodium guanylate or a mixture thereof, wherein the salt replacing composition does not comprise salts of glutamic acid and wherein % by weight is based on the anhydrous form of the inosinate and the guanylate and the total weight of the salt replacing composition.

17. A table salt comprising the salt replacing composition of claim 1.

18. The salt replacing composition of claim 5, comprising citric acid.

19. The salt replacing composition of claim 5, comprising potassium bitartrate.

20. The salt replacing composition of claim 7, comprising sucrose.

21. The salt replacing composition of claim 9, comprising sodium lauryl sulfate.

22. A reduced salt composition, comprising:
the salt replacing composition of claim 1 and from 1% to 99% by weight of sodium chloride.

23. A process for preparing the salt replacing composition of claim 1, comprising:
carrying out at least one of blending, impact milling, ball milling, jet milling, spray drying, fluidized bed coating, agglomerating, and extruding, of potassium chloride granules with one or more additional components of the composition, to form a dry blend of the sodium chloride replacing composition.

24. A food containing the salt replacing composition of claim 1.

25. A food containing the reduced salt composition of claim 22.

26. A sodium chloride replacing composition, comprising:
(i) 75-95% by weight of potassium chloride,
(ii) 2-15% by weight of ammonium chloride,
(iii) 0.05-10% by weight of at least one of an amino acid and a salt of an amino acid,
(iv) up to 5% by weight of at least one organic acid selected from the group consisting of acetic acid, citric acid, tartaric acid, succinic acid, malic acid, lactic acid, fumaric acid, adipic acid, and ascorbic acid,
(v) up to 10% by weight of at least one sweetener selected from the group consisting of sucrose, trehalose, lactitol, erythritol, maltitol, sorbitol, mannitol, xylitol, a hydrogenated starch hydrolyzate, and a high intensity sweetener.
(vi) up to 5% by weight of at least one of a taste enhancing agent and a masking agent wherein the taste enhancing agent and the masking agent are selected from the group consisting of a flavor, a flavor adjuvant, a flavor enhancer, an emulsifier and mixtures thereof, and
(vii) up to 5% by weight of disodium inosinate, disodium guanylate, or mixtures thereof,
wherein % by weight is based upon the total weight of (i), (ii), (iii), (iv), (v), (vi), and (vii).

27. The salt replacing composition of claim 26, comprising at least one amino acid selected from the group consisting of lysine, arginine, and glutamic acid.

28. The salt replacing composition of claim 26, comprising at least one salt of an amino acid selected from the group consisting of lysine hydrochloride, arginine hydrochloride, and a salt of glutamic acid.

29. The salt replacing composition of claim 28, wherein the salt of an amino acid is one or more of a sodium salt, a potassium salt, and a calcium salt of glutamic acid.

30. The salt replacing composition of claim 26, wherein the organic acid (iv) is present in an amount of at least 0.1% by weight.

31. The salt replacing composition of claim 30, wherein the organic acid is present in the form of at least one of a sodium salt, a potassium salt, and a calcium salt.

32. The salt replacing composition of claim 26, wherein the sweetener (v) is present in an amount of at least 0.1% by weight.

33. The salt replacing composition of claim 26, wherein at least one of the taste enhancing agent and the masking agent (vi) is present in an amount of at least 0.1% by weight.

34. The salt replacing composition of claim 26, wherein the composition does not comprise any salts of glutamic acid, and (vii) disodium inosinate, disodium guanylate, or a mixture thereof is present in an amount of at least 0.1% by weight.

35. A table salt comprising the salt replacing composition of claim 26.

36. The salt replacing composition of claim 26, wherein the organic acid (iv) is citric acid present in an amount of at least 0.1% by weight.

37. The salt replacing composition of claim 26, comprising potassium bitartrate in an amount of at least 0.1% by weight.

38. The salt replacing composition of claim 26, wherein the sweetener (v) is present in an amount of at least 0.1% by weight and the composition comprises sucrose.

39. The salt replacing composition of claim 26, wherein at least one of the taste enhancing agent, the masking agent or a mixture thereof (vi) is present in an amount of at least 0.1% by weight and the salt replacing composition comprises sodium lauryl sulfate.

40. The salt replacing composition of claim 26, wherein each of (iv), (v), (vi), and (vii) are present in an amount of at least 0.1% by weight.

41. The salt replacing composition of claim 26, which does not contain any salts of glutamic acid.

42. The salt replacing composition of claim 26, further comprising one or more of a solvent and a diluent.

43. The salt replacing composition of claim 26, further comprising at least one of a solvent and as solid diluent in an amount of from 1 to 99% by weight based upon the total weight of the salt replacing composition.

44. A food containing the salt replacing composition of claim 26.

45. A reduced salt composition, comprising:
the salt replacing composition of claim 26 and from 1% to 99% by weight of sodium chloride.

46. A food comprising the reduced salt composition of claim 45.

47. The salt replacing composition of claim 26, in the form of a homogeneous powder comprised of particles having a particle size of from 1 μm to 3 mm.

48. The salt replacing composition of claim 26, further comprising at least one of an anti-caking agent and a flow agent.

49. A process for making the salt replacing composition of claim 26, comprising:
mixing at least components (i), (ii) and (iii) to form the salt replacing composition.
